(19) United States
(12) Patent Application Publication
(10) Pub. No.: US 2026/0216743 A1
(43) Pub. Date: Jul. 30, 2026

(54) RETAINER AND INLET VALVE FOR RECIPROCATING PUMPS

(71) Applicant: RIEKE PACKAGING SYSTEMS LIMITED, Leicestershire (GB)

(72) Inventor: Simon Christopher Knight, Bridgend (GB)

(21) Appl. No.: 19/148,525

(22) PCT Filed: Jan. 17, 2024
(86) PCT No.: PCT/EP2024/051040

§ 371 Date: Jul. 16, 2025

Related U.S. Application Data
(60) Provisional application No. 63/439,292, filed on Jan. 17, 2023.

(51) Int. Cl. B05B 11/10

(52) U.S. Cl. CPC B05B 11/1023; B05B 11/1047

(57) ABSTRACT

An assembly for reciprocating pump is made completely from the same grade of polymer, preferably polypropylene or polyethylene (in its comparatively more rigid grades) that match all other components in that pump. The assembly has a stem that moves in concert with actuation mechanism for the pump and a retainer coupled to and forming an inlet to the dispensing channel defined by the stem. A coaxially received sliding seal is captured around the stem and retainer and moves freely only during downward actuation to open a flow path for dispensed fluid. Wing members on the periphery of the retainer flex to ensure the assembly travels with minimal friction while also opening and sealing the inlet as desired/required.

### CROSS REFERENCE TO RELATED APPLICATIONS

This application claims priority to U.S. provisional patent application Ser. No. 63/439,292 filed on Jan. 17, 2023, which is incorporated by reference herein.

### FIELD OF THE INVENTION

This invention relates to a reciprocating dispenser pump, whose components are all constructed from the same polymeric material, with an improved sealing and valve mechanism having a flexible wing disposed within the pumping chamber.

### BACKGROUND

Containers for everyday household fluid products, such as soaps, cleaners, oils, consumable liquids, and the like, can be outfitted with dispensing pumps to improve a consumer's experience in accessing and using those fluids. Dispensing pumps of this type tend to rely on reciprocating action that is driven by a compressible, metallic biasing member.

Many product containers are designed as single use, thereby giving rise to concerns about sustainability. In response, regulatory authorities now expect consumer products manufacturers to use product packaging and designs that can easily be recycled. As a practical matter, it is increasingly important for recycled products to be made only from polymeric materials. In this manner, such “all-polymer” pumps can be recycled without the need to disassemble and/or separate out metal parts and components made from difficult to recycle materials (e.g., metallic or foil parts, thermosetting resins, specialized elastomers, and other materials that either cannot be recovered or that require temperatures and conditions for recycling that are incompatible with the materials used in the other parts within the design). More ideally, all components will be made from a single grade of polymeric resin (e.g., all polypropylene).

Reciprocating pumps coupled to containers are well-known. U.S. Pat. Nos. 11,446,692; 11,413,638; 11,173,508; and 10,953,421 and United States Patent Publications 2020/0346235 and 2019/0118205 (all of which are incorporated by reference) disclose conventional reciprocating pumps with improvements to the venting and locking mechanisms. Notably, all of these disclosures all employ metallic, coiled spring biasing members, which are incompatible for all-polymer and single polymer designs.

While metallic springs are proven and cost effective, an increasing number of all-plastic biasing members are available. In fact, early iterations can be found in Patent Cooperation Treaty Publication WO 1994/020221A1 and U.S. Pat. Nos. 5,819,990 and 5,924,603 (the latter being incorporated by reference). U.S. Pat. No. 10,549,299 and United States Patent Publication 2018/0318861, along with Patent Cooperation Treaty Publications WO 2022/038194 and WO 2022/038199, provide more recent alternatives in which the entirety of the dispensing pump-including its biasing member—are constructed completely from polymeric and recyclable materials.

A separate consideration involves pump designs with locking and sealing mechanisms to enable transportation within little to no protective packaging (sometimes referred to as “e-commerce shipping” designs). United States Patent Publication 2019/0118205 discloses a reciprocating pump with rotational locking and catch mechanisms making the pump appropriate for e-commerce shipping. This particular design includes a “sliding seal” piston that, in conjunction with a conventional inlet ball valve, selectively seals or admits fluid into the pumping chamber.

Patent Cooperation Treaty Publications WO2021/013962 and WO2021/013966 disclose single polymer construction pumps with other e-commerce sealing mechanisms. In particular, these designs use an all-plastic bellows in combination with an internally carried plug that is designed to obstruct the inlet to the pumping chamber before the pump is used. However, to the extent the aim is to create a polymeric and, more preferably, single polymer pump, the selected plastic resin must possess a balance of strength and resilience. So, the use of comparatively “soft” low density polyethylene (LDPE) as required by some of these designs to create plug seal interfaces may not be appropriate for high-wear parts that may be subjected to cyclic periods of stress and relief (e.g., as might be the case where interfacing parts must seal an aperture when locked but also slide over one another when operable). Conversely, more rigid polypropylene and high density polyethylene (HDPE) resins possess sufficient rigidity that these parts may create excessive friction and “stickiness” along their sliding surfaces, thereby limiting their widespread adoption in high-wear components (or, at a minimum, requiring selective use of softer resins and/or more conventional elastomers for selected elements, such as sealing interfaces).

All of the foregoing disclosures are incorporated by reference as if fully reproduced herein. These disclosures may inform and supplement this disclosure with respect to materials selection, construction, component design, and various other aspects of this disclosure and any claims based thereon.

While a good number of these designs represent viable all-polymer (i.e., no metallic parts) designs, single-polymer (i.e., all components constructed from the same polymer or, at least, grades of polymer that are compatible for single-stream recycling) are preferred because they can be recycled more easily. Therefore, a single-polymer pump with an improved inlet valve would be welcome. In particular, an inlet valve design that operated in conjunction with a sliding seal carried inside of the pump chamber could eliminate the need for a separate inlet ball valve. Further, none of these designs contemplate a single-polymer pump that is specifically engineered to include comparatively stiff, recyclable polymer, such as polypropylene or polyethylene, with flexible valve-like mechanisms to control fluid flow through the pump as it is actuated. Lastly, an all-polypropylene or all-HDPE design that avoided problems associated with the rigidity of these materials is needed.

### SUMMARY OF INVENTION

Generally, an assembly for use in reciprocating pumps is made entirely from polypropylene, which is advantageous to the extent it is stiffer and more durable than many polyethylene blends (polypropylene can also be cast as a translucent polymer, which may also be a preferred aesthetic). The assembly can be installed in virtually any pump or dispenser design which relies upon a member defining a flow/dispensing channel that moves in a generally vertical direction to actuate pumping/dispensing, and it effectively acts as a valve and shipping seal.

In one aspect, a stem defines a flow channel that connects to the dispensing outlet of the pump. The stem is also attachable to the axially reciprocating elements of the pump (e.g., the dispenser head, which is urged into an extended position by a biasing member). An annular sliding seal member is fitted coaxially around a retainer that couples to the bottom end of the stem, thereby capturing the sliding seal member. Cooperating abutments on the sliding seal and the retainer and/or stem define a range of motion over which the sliding seal may travel as the stem is pushed downward, thereby temporarily opening a fluid flow path between the sliding seal and the retainer. In turn one or more radial inlets in the retainer allows fluid to pass into the dispensing channel.

The retainer also includes, at its periphery, a winged flexible member. This member conforms to the sliding seal to ensure the entire assembly moves smoothly within the pump chamber. Previous iterations of pumps using a sliding seal member, as seen in FIGS. 6A through 6D, required a softer polymer to prevent the assembly from “sticking” or otherwise providing unwanted resistance during actuation and release of the dispenser.

The stem, retainer, and sliding seal are all made from the same grade of polymeric resin, preferably polypropylene. Notably, the other components of the pump, including the biasing member, actuator head, and closure assembly are also made of this same polymer (i.e., polypropylene). In this manner, the entirety of the dispensing pump may be introduced to single stream recycling, without the need for disassembly/removal of metallic or elastomeric parts and without further separation or accommodating of chemically distinct polymers (e.g., polypropylene vs. LDPE, acrylics, elastomeric polymers, etc.).

### BRIEF DESCRIPTION OF THE DRAWINGS

The appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure.

FIG. 1A is a perspective view of the stem, seal, and retainer assembly according to various disclosed aspects, while FIG. 1B is a perspective cross sectional view, taken along its diameter, of that assembly. FIG. 1C is a perspective cross sectional view, taken along a quarter section arc, of that assembly as it is installed within an exemplary, reciprocating pump with a single polymer biasing member.

FIG. 2A is an isolated, perspective view of the retainer of FIG. 1A, while FIG. 2B is a cross sectional side view taken along line 2-2 of FIG. 2A to highlight the radial inlets and winged flex members of the retainer. FIGS. 2C and 2D are complimentary top and bottom perspective views of the retainer highlighting the positioning of support structures and interfaces positioned proximate the winged flex members and/or radial inlets.

FIG. 3A is a cross sectional side view, similar to that of FIG. 2B, of the stem, sliding seal, and retainer assembly. FIG. 3B is a complimentary cross sectional side view of that assembly, taken at an orthogonal diameter to that of FIG. 3A, with both views highlighting the multiple sealing surfaces formed between the retainer and the sliding seal when the assembly is at rest, locked, or in an “upstroke” motion. FIG. 3C is an identical view to that shown in FIG. 3A, except that FIG. 3C illustrates the positioning of the components as the sliding seal travels during its downstroke motion, with the arrow F indicating the flow path of fluid through the sliding seal and retainer assembly during downstroke/active dispensing.

FIG. 4 is a partial cross sectional side view highlighting how the wing segment 161 of the retainer bends/flexes between positions 161a and 161b during the upstroke portion of reciprocation, thereby eliminating unwanted “sticking” sometimes sensed by the user.

FIGS. 5A, 5B, and 5C show, respectively speaking, perspective, side plan, and cross sectional side views of the individual components of the assembly of FIG. 1A, with the cross sectional side view taken along a diameter of the assembly.

FIGS. 6A, 6B, and 6C are corresponding views (relative to FIGS. 5A through 5C) showing a conventional, non-flexible retainer that might otherwise be used, while FIG. 6D is a corresponding cross sectional side view (relative to FIG. 3A) of this conventional, non-flexible retainer.

### DESCRIPTION OF THE SELECTED EMBODIMENTS

Operation of the invention may be better understood by reference to the detailed description, drawings, claims, and abstract-all of which form part of this written disclosure. While specific aspects and embodiments are contemplated, it will be understood that persons of skill in this field will be able to adapt and/or substitute certain teachings without departing from the underlying invention. Consequently, this disclosure should not be read as unduly limiting the invention(s).

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

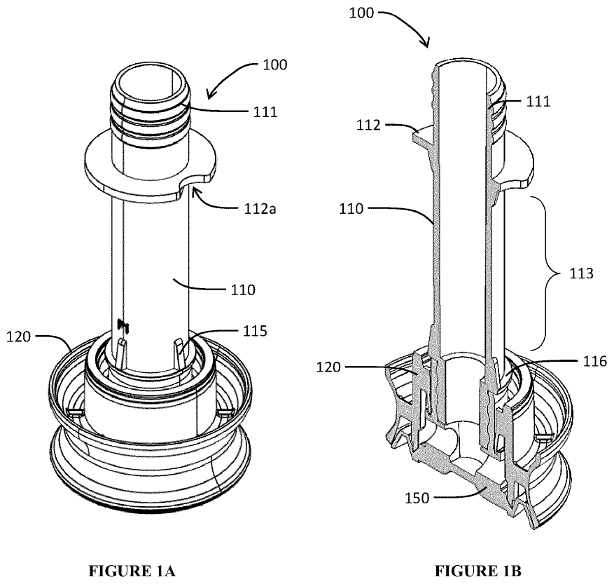

With reference to FIGS. 1A through 1C, a reciprocating pump 10 includes a pump engine 20, an actuator 30, and a closure 40. The engine 20 typically includes a biasing member 21 and pump cylinder 22. The biasing member 21 urges the head 31 and stem 32 upward and away from the closure 40. In this manner, fluid is forced out of the pump chamber 22 (but only after it is primed) when the actuator 30 is depressed, while creating suction to draw fluid into the engine 20 as the actuator 30 returns to its extended position.

Critically, owing to legislative trends and consumer demands, the entirety of the pump 10 is made from recyclable materials. More ideally, this would be a single grade of polymer, selected specifically for its low cost, durability, and non-toxicity. Thus, engine 20, actuator 30, and closure 40 are all made from the same polymer so as to allow the entirety of the pump 10 to be recycled. As noted elsewhere herein, polypropylene (and more rigid grades of polyethylene) are particularly well-suited.

As documented in the references incorporated above, creation of specific components from the same grade of material is extraordinarily challenging. For example, the biasing member 21 must be sufficiently strong but resilient to sustain thousands of actuation strokes. Conversely, the pump cylinder 22 (and components coming into contact with it) must be strong but sufficiently low friction to minimize actuation force and improve user experience. Still further, the actuator 30 and closure 40 components must be non-reactive (relative to both the dispensed fluid and ambient environment) and capable of maintaining a water-tight seal, including valves and dispensing/fluid flow path channels. Thus, elastomers, low-density polyethylene, and other polymers and copolymers normally used in specific components for mixed-source pumps (i.e., pumps having a metallic spring and/or different grades and types of polymers/copolymers) are not viable for pump 10.

The disclosures incorporated above in regard to all-plastic biasing members and, separately, various rotational locks, catch mechanisms, and other sealing strategies for a reciprocating pump are appropriate for use with the inventive assembly 100. Similarly, any conventional container that can be coupled to a pump closure is suitable for use with pumps incorporating the assembly 100.

Assembly 100 comprises three basic elements: stem 110, piston 120, and retainer 150. All three elements are constructed from the same polymer, preferably by way of injection or other molding or by way of other known high-volume, low-cost production methods appropriate for such polymers.

Stem 110 is essentially tubular so as to define the channel for fluid passing from the container (via the pump chamber) and out of the dispensing nozzle found in the actuator 20. Preferably, the stem 110 will be an axially elongated and hollow circular cylinder. Coupling formations 111 are located on its top end, preferably along its outer circumference, so as to attach to similar formations on the actuator 20, thereby causing the pieces to move in unison. Radial flange 112 can be formed along its upper reaches to cooperate with the biasing member 21 and/or to play a roll in the catch and/or locking mechanisms. Accordingly, flange 112 may include one or more locating notches 112a that are effectively shaped to allow passage of structures affixed to the closure 40 so as to impede or prevent axial travel when the actuator 20 (and the stem 110) are rotated relative to the closure 40. The outermost periphery of the flange 112 need not conform to the circular shape of the stem 112, as an alternative or additional means of locating a specific radial alignment and/or engaging locking and catch mechanisms.

Midsection 113 has thin straight sidewalls that are comparatively thinner than the top end or the lower portion. This arrangement reduces materials use and costs, while ensuring the reciprocating motion (and any catch or locking mechanisms) function as expected.

The lower end includes coupling formations 114 which cooperate with the retainer 150. Outer ribs 115 provide structural support to circumferential stop 116 that may serve to align the fit between the stem 110 and the retainer 150, as well as delimit the upward range of motion for the sliding seal piston 120.

Except for the flange 112, the top and middle sections of the stem 110 may possess similar or identical outer and inner diameters and substantially similar wall thicknesses along every radial cross section (excepting those areas reinforced by ribs 115 and/or possessing the locating notch 112a). The lower opening of the stem 110 has a reduced outer diameter, as well as preferably a reduced inner diameter along the section where the formations 114 are positioned.

Piston 120 is necessarily provided as a separate annular piece that coaxially receives the stem 110 and retainer 150 so as to allow for a range of axial movement defined by the stop 116 on the stem at the top end and the sloped stopping surface(s) on the retainer at the lower end. In particular, the sliding seal piston 120 will have a substantially similar (if not identical) shape and thickness along its entire circumference.

The profile of a single, radial cross section of the piston 120 suggests a modified H-shape. In particular, on its outer most periphery, axially offset wiper arms 121a, 121b extend radially away from an outer facing of cylindrical wall 122. On the inner facing of wall 122, a radial extension 123a serves as an up[per stopping surface and connects to an angled engagement wall 124. The lower extremities of wall 124 sealingly engages the retainer 150, but the wall 124 is thinned in comparison to inward radial extension 123a to ensure the piston 120 may slide freely up and down along the retainer 150. The bottom edge of wall 124 is seated within an annular groove 153a formed in the upper facing of section 153. Extension 123a has a cooperating surface, preferably oriented on a horizontal plane to engage stopper 116 and prevent the piston 120 from sliding axially onto the midsection 113 of stem 110.

Outward radial extension 123b is positioned on an opposite side of cylindrical wall 122 (relative to extension 123a), possibly at a lower elevation. Wiper arms 121a, 121b attach to the extension wall 123b, while the cylindrical wall 122 extends below the elevation of the extension 123b. This lower portion 125 of wall 122 reduces in thickness and includes a cooperating, preferably angled section 125a that conforms and sealingly engages a seat or trough formed by intersection of selected elements, as described below. Thus, section 125a provides a second means to seal and close the flow path (with the wiper 121b coming into contact with wing 161 providing the first such seal). Because two separate seals are contemplated, it becomes possible to tolerate flexing along the periphery without degrading the seal (which would, in turn, degrade pump performance and user experience).

One or more support ribs 126 may be disposed along inner or outer surfaces of the various piston walls 122, 123, 124. Preferably, axially aligned and evenly spaced ribs 126 provide support for the engagement wall 124. Radial ribs may also be spaced apart above and/or below the extension wall 123b. Ribs 126 ensure that piston 120 retains sufficient structural strength to seal to the stem 110 and retainer 150 as required for proper functioning of the sliding seal.

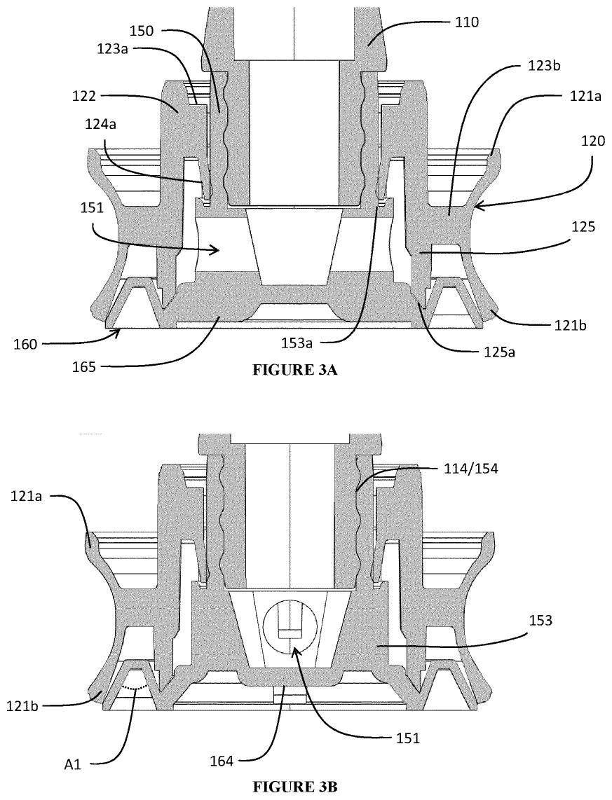

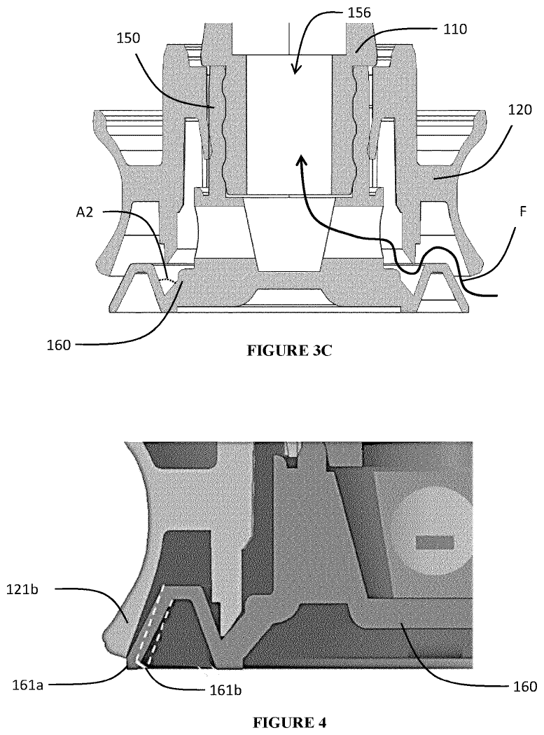

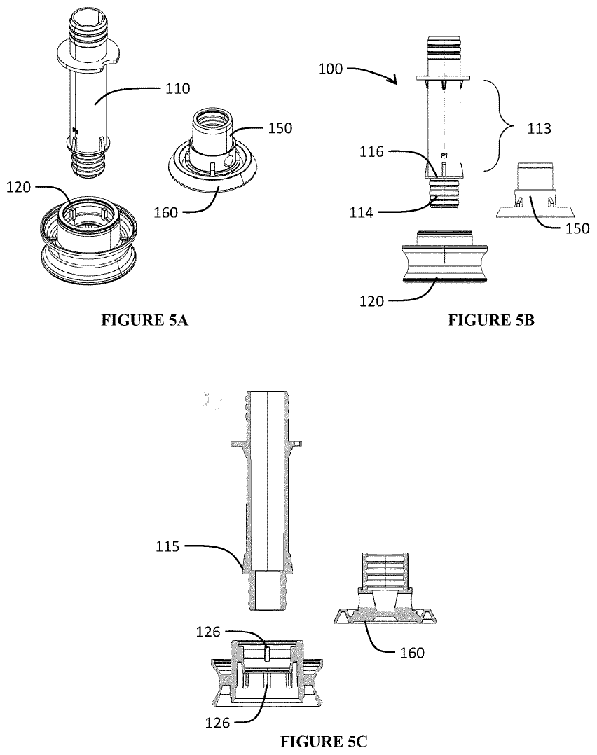

The configuration of extension 123a, wipers 121a, 121b, and angled section 125a is such that, when the piston slides upward as the stem 110 is pushed down, sufficient space is provided to create temporary separation between the piston 120 and the retainer 150. More specifically, a flow path F is established beneath the wiper arm 121b and the underside of extension 123b, as well as around the lower tip of section 125, 125a-specifically, as seen in FIG. 3C, fluid will be forced into the radial inlets 151 and through the outlet connection 156 as the stem/plunger travels downward. When the stem 110/pump 10 is at rest (or locked) and when the stem 110 is returned/returning to its extended position (both as shown in FIGS. 3A and 3B), arm 121b and angled section 125a seal and block any fluid from draining out of the stem 110 and back into the container. As is common in this field, a separate valve member may be positioned above the outlet 156 (e.g., within or proximate to the head 30, possible as a flap or ball valve) to facilitate retention and dispensing of any fluid previously drawn in through the inlets 151.

Retainer 150 is configured to snap on to the lower end of the stem 110 by way of coupling formations 154. The retainer is hollowed in portions, preferably defining one or a series of L or T shaped flow paths that connect to the channel beginning at the bottom of the stem 110.

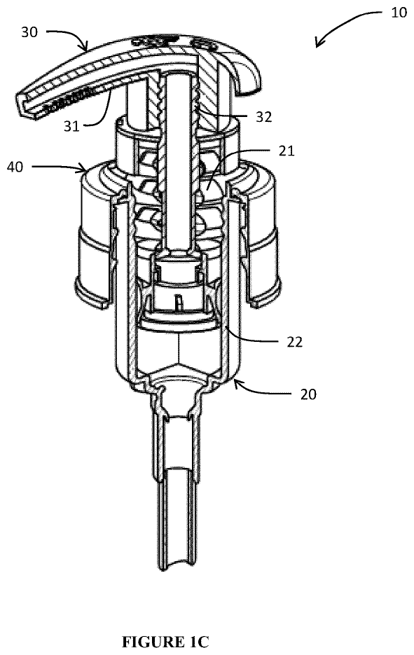

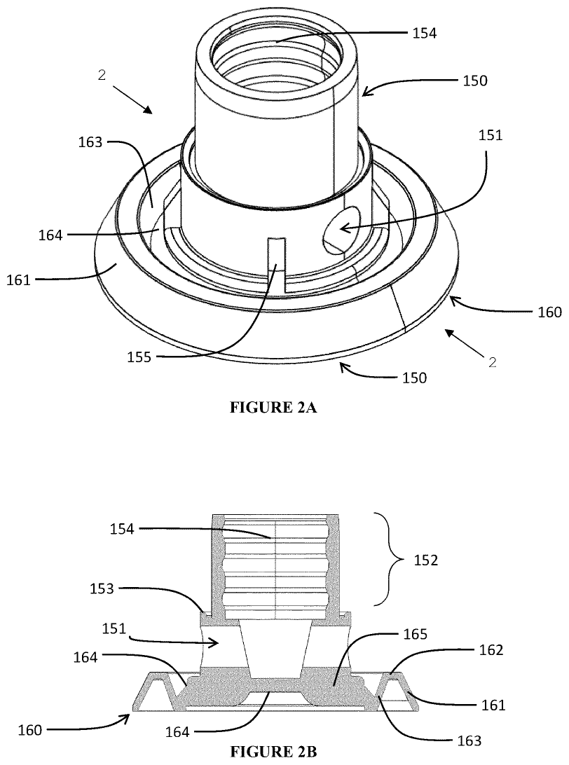

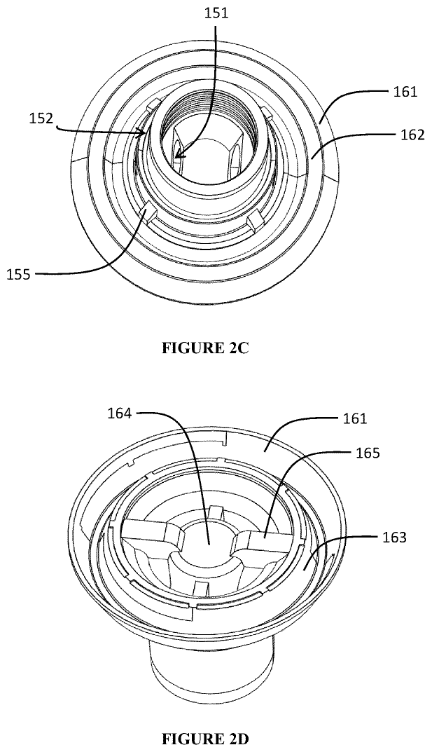

Formations 154 are formed on a thinned wall section 152 at the top end of the retainer 150. Specifically, formations 154 cooperate with formations 114 to seal the stem 110 to the retainer 150, while one or more radial inlets 151 (two are shown in FIGS. 2B and 3A) serve as an extension of the flow channel defined by the stem 110. A thickened cylindrical section 153 may also rely on outer support ribs 155 to provide strength.

Retainer 150 terminates at its lower end with a grooved radial flange or disk-like element 160 having a diameter substantially larger than the outer diameter of wall 152. In particular, disk 160 attaches to section 153 and may include inner support ribs 165 on the lower facings. Central blocking portion 164 imparts the aforementioned L or T shape to the flow path. Winged segments 161, 162, 163 extend out from the central portion 164 at specific, varying angles to allow the disk 160 to seal to the piston 120 while also providing sufficient flexibility, particularly at segment 161 to permit the retainer 150 to move upward in concert with piston 120. Notably, the flexibility of segment 161 reduces friction that might otherwise cause the piston 120 to feel as it is “stuck” along the inner facing of pump cylinder 22.

Segments 161, 162, 163 preferably have the same thickness and impart an inverted V-shape along the periphery of disk 160. Segment 162 may extend in a horizontal plane at an elevation proximate to the bottom edge of the inlets 151. Segments 161, 163 attach to segment 162 at complimentary angles (relative to the plane defined by segment 162). In some aspects, the segments 161, 163 may attach at the same angle and the liner length of the segments 161, 162, and/or 163 may be approximately equal.

Additionally, segment 163 attaches to the central portion 164 so as to create an angled trough that conforms to segment 125a on the piston 120. As noted above, this seal these elements except when the stem 110 is travelling downward during actuation (at which point piston 120 temporarily slides up to open the flow path, thereby allowing fluid to pass and be dispensed out of the pump).

Similarly, the angle of segment 161 provides a sealing contact with wiper arm 121b. Again, as noted above, this sealing arrangement blocks fluid flow except when the piston 120 slide upward. Further, the arm 121b may exert radial force on the segment 161 so as to cause it to flex inward as the piston 120 moves through its range of motion.

It should be understood that the comparative size, spacing, and angle/position of the wing segments 161, 162, 163 and the outer radial surface of portion 164 are important. In this regard, FIGS. 3A through 3C are drawn to scale, and the wings 161, 162, 163 tend to be of uniform thickness, as well as thinner than the central portion 164. Notably, the bottom facings of segments 161 and 163 and the top facings of segment 163 and portion 164 each form acute angles A1 and A2, respectively. More preferably and specifically, A1 and A2 are each between 20° and 70° or between 30° and 60°. In some aspects, A2 is greater than A1 and, more particularly, A1 is approximately 40° and A2 is approximately 60°.

Along the bottom facing (e.g., as seen in FIG. 2D), the outermost periphery of the disk 160 is characterized by a diameter of the central member 164 (i.e., at the point where wing 163 connects to the central member 164) that is approximately 70% in comparison to the diameter of the outer wing 161. In the same manner, the axial height of wing segment 162 (which represents the highest elevation of the flexing portion of the retain 160) will be at or below the elevation of the bottom edge of the radial inlet 151. It will also be understood that wiper edge 121b will descend to an elevation that is below the lower-most tip of wall segment 125a, although the edge 121b will still rest on and seal to an upper/outer facing of the wing 161.

Without intending to be bound by any theory of operation, the foregoing arrangements enable the retainer and sliding assembly to move, release, and seal as is required to facilitate operation of the dispensing pump.

The arrangement of the stem 110, piston 120, and retainer 150 requires sequential assembly to ensure the components function as intended. Specifically, the piston 120 must be seated down on the retainer 150 before the retainer 150 is coupled to the stem 110. The features on the bottom of disk 160 align in a common horizontal plane so as to allow the assembly 100 to fit easily and move smoothly within the pump engine/cylinder 20.

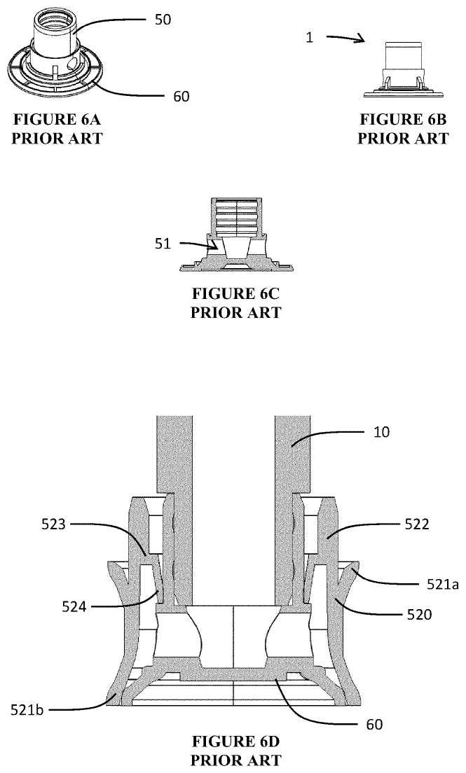

FIGS. 6A through 6D illustrate a conventional retainer 1 that may be incorporated in pumps similar to the one shown in FIG. 1C (or, alternatively, in United States Patent Publication 2019/0118205). Retainer assembly 50 is coupled to stem 10, which may be similar to stem 110 above. Conventional retainer 50 includes a flat or concave disk element 60, whose comparatively thicker construction (particularly at the periphery and in direct contrast to wings 161, 162, 163 above) provide greater stiffness so as to prevent flexing along its periphery when the wiper 521b of piston 520 is in contact therewith. This piston 520 itself is also more elongated, with wipers 521a, 521b both positioned below the radial extension 523, while axial wall 522 and stopper wall 524 are positioned on above and below it. Notably, wiper element 521b is the only surface capable of sealing/closing radial inlet 51, and any flexion or disruption of that contact would negatively impact suction and sealing within the pump engine. Accordingly, this conventional design was premised on maintaining this seal, and required sufficiently strong and less flexible materials for the design of the components in the sliding seal.

It is believed this lack of flexibility increases friction between the inner walls of the pump chamber, thereby impeding the smooth and easy actuation of the pump. The interface of polypropylene-to-polypropylene also led to imperfect sealing which further impeded the effectiveness of the pump engine itself. In fact, the inventors have established, through various experiments, that when the retainer 50 and disk 60 are molded with polypropylene, the resulting assembly 1 provides inadequate pumping performance in comparison to identical pump components made from softer materials. However, stiffer materials such as polypropylene and/or HDPE would be more desirable owing to their higher stiffness/strength (particularly to the extent that a true one-polymer design is preferred for minimizing manufacturing cost/complexities, as well as for the consumer/user ability to more easily recycle such single-polymer products).

The piston assembly described herein effectively serves as a “sliding seal” valve element in a reciprocating dispenser/pump. As such, the piston is configured to seal to an inner surface of the pumping chamber of such pumps, while the combination of the stem, piston, and retainer move in concert with the actuator head/mechanism and provide a valve that opens and closes depending upon whether the actuator is moving downward (thereby sliding the piston up and temporarily opening the inlet(s) on the assembly) or at rest/moving upward (in which case the piston block and seals the inlet(s) on the assembly). Accordingly, the assembly can be introduced into a suitable dispensing pump design, although it presents the clearest advantages for those whose components are all made from (e.g., via injection molding) the same grade of polymer and, more ideally, from polypropylene or high density polyethylene.

Thus, in one embodiment, a valve assembly for an axially reciprocating pump is described. This assembly includes three main components: i) a retainer member having a hollow tubular construction defining an outlet at a top facing and having at least one radially aligned inlet positioned at a bottom end of the retainer member; ii) a disk-shaped cap extending radially away from the bottom end, the disk shaped cap including a central section having an angled top facing, an inner wing section attached to the central section at a first angle, and an outer wing section attached to the inner wing section at a second angle and wherein the outer wing section is configured to temporarily bend inwardly in response to force applied on a top facing of the outer wing section; and iii) a piston configured to be slidingly received on an outer facing of the bottom end of the retainer member, the piston including an inner tubular section with radial extension attaching to an outer wiper element. In this arrangement, when the piston is seated on the disk-shaped cap, a lower most edge of the inner tubular section is seated in the first angle to form a first seal of all radial inlets and the outer wiper element includes a lower most edge that rests on the top facing of the outer wing section to form a second seal of all radial inlets and, when the piston is temporarily slid upwards along the retainer body, an upper most edge of the inner tubular section serves as a stopping surface. Further aspects in this embodiment can include any one or combination of the following elements:
wherein the first angle is equal to or greater than the second angle;
wherein both the first angle and the second angle are each between 20° and 70°;
wherein the disk-shaped cap terminates in a common horizontal plane;
wherein an outer diameter of the central section is about 70% of an outer diameter of the outer wing section;
wherein a horizontal transition section is provided between the inner wing and the outer wing;
wherein an axial elevation of a top most facing of the horizontal transition section is beneath an axial elevation of a lower most edge of all the radial inlets; and,
wherein the retainer member, the disk-shaped cap, and the piston are all made of a single polymer material selected from: high density polyethylene and polypropylene.

In another embodiment, a valve attachment for a reciprocating dispenser pump is contemplated. Here, a stem is configured to couple to the actuator of a reciprocating pump, and the stem has a hollow tubular member with coupling features. Additionally, a retainer element is coupled to a bottom end of the hollow tubular member to form a stem extension, and the retainer element has an L- or T-shaped flow path through a hollow central portion and a bottom flange with an annular V-shaped radial wing positioned between at least one inlet defined in a sidewall of the retainer element. Notably, the inlet and the radial wing are positioned beneath the lowermost end of the hollow tubular member. Finally, the assembly includes a sliding piston, fitted coaxially around the stem and the retainer element, having: i) a cylindrical sidewall configured to seat in a groove defined by the radial wing, ii) an inwardly extending flange including an upper stopper configured to abut a corresponding stopper on the stem extension, and iii) and an outwardly extending flange configured to create a sliding and sealing interface with a pump chamber of the reciprocating pump. In this embodiment, the inwardly extending flange maintains a sliding and sealing interface with a corresponding surface of the stem extension and wherein the corresponding stopper and the inlet are spaced apart at a sufficient height to allow the piston to open the inlet as the valve attachment travels downward during pump operation and to seal the inlet when the valve attachment is urged into contact with the retainer element. Further aspects of this embodiment include any one or combination of the following elements:
wherein the outwardly extending flange creates a seal at an outermost periphery of the radial wing;
wherein the cylindrical sidewall creates a seal with the radial wing;
wherein a bottom terminal edge of the cylindrical sidewall has an angled profile that matches an angled profile on an upper surface of the radial wing;
wherein the outermost periphery of the radial wing is configured to flex radially inward during operation of the reciprocating pump; and
wherein the stem, the retainer element, and the sliding piston are all made of one selected from: high density polyethylene and polypropylene.

All components of the pump dispenser should be made of materials having sufficient flexibility and structural integrity, as well as a chemically inert nature. Certain grades of polypropylene and polyethylene are particularly advantageous, especially in view of the absence of any thermosetting resins, elastomeric polymer blends, and other chemically distinct polymers or copolymers (in comparison to the other components of the dispensing pump). Notably, high density polyethylene (i.e., having a density of greater than 0.940 g/cm³) possesses certain advantages over lower density polyethylene types (e.g., medium density at 0.925 to 0.940 g/cm³ and/or lower density at 0.880 to 0.925 g/cm³), as well as allowing for consideration of other specialized, stiffer versions capable of cross-linking. Nevertheless, the invention may be implemented relying on injection moldable polyolefins, with particular utility in polypropylene and polyethylene.

In the foregoing description, it will be understood that phrases such as upper and top should be interpreted both in a comparative sense (to the extent corresponding lower or bottom components, facings, etc. are identified) as well as in a more literal sense to the extent the orientation of the components within the drawings is generally preserved, with upper components facing toward the top of each drawing sheet. Further, to the extent many components possess a cylindrical shape, the term axial refers to the height or elongated direction of that cylinder (e.g., top to bottom on the drawing sheets) whereas radial generally corresponds to lengthwise or lateral directions (e.g., left to right on the drawing sheets).

References to coupling in this disclosure are to be understood as encompassing any of the conventional means used in this field. This may take the form of snap- or force fitting of components, although threaded connections, bead-and-groove, and bayonet-style/slot-and-flange assemblies could be employed. Adhesive and fasteners could also be used, although such components must be judiciously selected so as to retain the recyclable nature of the assembly.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

1. A valve assembly for an axially reciprocating pump, the assembly comprising:
a retainer member having a hollow tubular construction defining an outlet at a top facing and having at least one radially aligned inlet positioned at a bottom end of the retainer member;
a disk-shaped cap extending radially away from the bottom end, the disk shaped cap including a central section having an angled top facing, an inner wing section attached to the central section at a first angle, and an outer wing section attached to the inner wing section at a second angle and wherein the outer wing section is configured to temporarily bend inwardly in response to force applied on a top facing of the outer wing section; and
a piston configured to be slidingly received on an outer facing of the bottom end of the retainer member, the piston including an inner tubular section with radial extension attaching to an outer wiper element;
wherein, when the piston is seated on the disk-shaped cap, a lower most edge of the inner tubular section is seated in the first angle to form a first seal of all radial inlets and the outer wiper element includes a lower most edge that rests on the top facing of the outer wing section to form a second seal of all radial inlets; and
wherein, when the piston is temporarily slid upwards along the retainer body, an upper most edge of the inner tubular section serves as a stopping surface.

2. The valve assembly of claim 1 wherein the first angle is equal to or greater than the second angle and wherein both the first angle and the second angle are each between 20° and 70°.

3. The valve assembly of claim 2 wherein the disk-shaped cap terminates in a common horizontal plane.

4. The valve assembly of claim 3 wherein an outer diameter of the central section is about 70% of an outer diameter of the outer wing section.

5. The valve assembly of claim 2 wherein a horizontal transition section is provided between the inner wing section and the outer wing section.

6. The valve assembly of claim 5 wherein an axial elevation of a top most facing of the horizontal transition section is beneath an axial elevation of a lower most edge of all the radial inlets.

7. The valve assembly of claim 6 wherein the retainer member, the disk-shaped cap, and the piston are all made of a single polymer material selected from: high density polyethylene and polypropylene.

8. The valve assembly of claim 4 wherein the retainer member, the disk-shaped cap, and the piston are all made of a single polymer material selected from: high density polyethylene and polypropylene.
